(19) United States
(12) Patent Application Publication
(10) Pub. No.: US 2009/0096326 A1
(43) Pub. Date: Apr. 16, 2009

(54) PIEZOELECTRIC ACTUATOR, ACOUSTIC COMPONENT, AND ELECTRONIC DEVICE

(75) Inventors: Yasuharu Onishi, Tokyo (JP); Yasuhiro Sasaki, Tokyo (JP); Nozomi Toki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Minato-ku (JP)

(21) Appl. No.: 12/063,746

(22) PCT Filed: Aug. 30, 2006
(86) PCT No.: PCT/JP2006/317054

§ 371 Date: Feb. 13, 2008

(30) Foreign Application Priority Data
Aug. 31, 2005 (JP) 2005-252213

(51) Int. Cl. H04R 17/00

(52) U.S. Cl. 310/334

(57) ABSTRACT

A piezoelectric actuator capable of providing high sound pressure and excellent frequency characteristics when it is used as an acoustic element and advantageous for a reduction in size. The piezoelectric actuator (50) comprises a piezoelectric element (10) performing such an expansion/contraction motion that its principal plane is expanded or contracted according to the state of a filed, a pedestal (24) on which the piezoelectric element is stamped, and four beam parts (30) connected to the outer peripheral parts of the pedestal (24). The pedestal (vibrating part) is vertically vibrated according to the expansion/contraction motion of the piezoelectric element (10). Each of the beam parts (30) comprises an extension part (35) extending from the outer peripheral part of the pedestal (24) to the outside and a rise part (36) continuously extended from the extension part (35) in a direction perpendicular to the extended direction of the extension part (35).

### TECHNICAL FIELD

The present invention relates to a piezoelectric actuator for generating vibrations using a piezoelectric element, and an acoustic component and an electronic device which employ such a piezoelectric actuator.

### BACKGROUND ART

Heretofore, electromagnetic actuators have been used as the drive source of acoustic components such as speakers. An electromagnetic actuator comprises a permanent magnet and a voice coil, and generates vibrations through on the action of the magnetic circuit of a stator comprising magnets. An electromagnetic speaker produces sounds by vibrating a low-rigidity vibratory plate such as an organic film or the like which is fixed to the vibrator of an electromagnetic actuator.

In recent years, there has been a growing demand for cellular phones and personal computers, and a corresponding demand for small and power-saver actuators has been increasing. The electromagnetic actuator is required to supply a large current to the voice coil for generating magnetic forces. Accordingly, the electromagnetic actuator is problematic as a power saver. The electromagnetic actuator is structurally unsuited for being made smaller and thinner. In addition, if the electromagnetic actuator is to be incorporated in an electronic device, it needs to be electromagnetically shielded to prevent harmful effects caused by magnetic fluxes leaking from the voice coil. The electromagnetic shield makes the electromagnetic actuator inappropriate for use in small-size electronic devices such as cellular phones or the like. Attempts to reduce the size of the electromagnetic actuator result in a thinner voice coil wire having a greater resistance value, which tends to lead to possible voice coil burnout.

In view of the above problems, there has been developed a piezoelectric actuator having a piezoelectric element as a drive source. The piezoelectric actuator has features such as small size, light weight, power saving capability, and no flux leakage, which allow itself to be used as a thin vibratory component to replace the electromagnetic actuator. The piezoelectric actuator has a structure comprising a piezoelectric ceramic element (also simply referred to as “piezoelectric element”) and a base which are joined to each other. The piezoelectric actuator produces mechanical vibrations based on the motion of the piezoelectric element operates.

The basic structure of a piezoelectric actuator will be described below with reference to FIGS. 31 and 32. FIG. 31 is a perspective view showing the structure of a piezoelectric actuator of the related art, and FIG. 32 is a cross-sectional view schematically showing the manner in which the piezoelectric actuator shown in FIG. 31 vibrates.

As shown in FIG. 31, piezoelectric actuator 550 comprises piezoelectric element 510 made of piezoelectric ceramics, base 524 to which piezoelectric element 510 is fixed, and support member 527 supporting an outer circumferential portion of base 524. When an alternating voltage is applied to piezoelectric element 510, piezoelectric element 510 expands and contracts. As shown in FIG. 32, base 524 is deformed into a convex mode (indicated by the solid line) and a concave mode (indicated by the broken line) depending on the expanding and contracting motion of piezoelectric element 510. Base 524 vibrates vertically as shown while joint 524a joined to support member 527 acts as a fixed end and a central region thereof acts as a moving region.

Though the piezoelectric actuator can advantageously be reduced in size and thickness, it is poorer than the electromagnetic actuator in terms of the performance of the acoustic component. This is because the piezoelectric element itself is highly rigid and the piezoelectric actuator is unable to provide a sufficient average vibration amplitude compared with the electromagnetic actuator. If the amplitude of the actuator is small, then the sound pressure of the acoustic component is also small.

JP-A No. 2000-140759 discloses a technology for supporting the outer circumferential portion of a base with relatively easily deformable beams to produce a large vibration amplitude. JP-A No. 2001-17917 discloses a technology for forming a slit in a peripheral portion of a base along the circumferential edge thereof to provide a leaf spring to produce a large vibration amplitude.

The above technologies will briefly be described below with reference to FIG. 33. FIG. 33 shows the structure of the piezoelectric actuator disclosed in JP-A No. 2000-140759. An outer circumferential portion of base 624 supporting piezoelectric element 610 and support member 627 are connected to each other by beams 630. This structure allows the vibratory body to vibrate greatly.

### DISCLOSURE OF THE INVENTION

### Problems to be Solved by the Invention

The structure disclosed in JP-A No. 2000-140759 produces a greater vibration amplitude than the structure shown in FIG. 31 wherein the entire outer circumferential portion of base 524 is fixed. However, if the vibration amplitude is to be increased, then it is necessary to increase the stroke of the beams, and the increased stroke of the beams naturally results in a larger actuator size.

The piezoelectric actuator disclosed in JP-A No. 2000-140759 is used as a vibrator for cellular phones, and does not take into account other applications such as being used as a speaker for reproducing music, etc. If the piezoelectric actuator is to be used only as a vibrator, then simply the sound pressure thereof may be increased. If the piezoelectric actuator is to be used as a speaker, then the vibration mode of the piezoelectric actuator including the frequency characteristics thereof needs to be considered.

The vibration mode will be described below with reference to FIG. 34. FIG. 34A shows the vibration mode of an electromagnetic actuator, which is a piston-type vibration mode in which the vibrating portion vibrates vertically on average. FIG. 34B shows the vibration mode of a general piezoelectric actuator, which is a flexural-motion vibration mode in which the amplitude of the central region is maximum. For improving the frequency characteristics of an acoustic component, it is desirable to bring the vibration mode of the piezoelectric actuator as close as possible to the piston-type vibration mode as much as possible. The structure disclosed in JP-A No. 2000-140759 basically produces a flexural motion though the amplitude is improved.

This also holds true for JP-A No. 2001-17917. According to the structure disclosed in JP-A No. 2001-17917, furthermore, since the beam is circumferentially formed (since the beam does not extend radially), the base may possibly induce a rotary motion when in operation. If such a piezoelectric actuator is used as an acoustic component, then problems such as distorted sounds may possibly occur.

The present invention has been made in view of the above problems. It is an object of the present invention to provide a piezoelectric actuator which can produce high sound pressure and good frequency characteristics when used as an acoustic component, and which can advantageously be reduced in size, and an acoustic component and an electronic device which employ such a piezoelectric actuator.

### Means for Solving the Problems

A piezoelectric actuator according to the present invention includes a piezoelectric element, a base, and a plurality of beam members. The piezoelectric element has two opposite principal surfaces and expands and contracts to cause the principal surfaces to be enlarged or shrunk depending on the state of an electric field. The base is made of a stretchable material, one of the principal surfaces being applied to the base. The beam members which provide beams have ends connected to an outer circumferential portion of the base and other ends connected to a support member. The base is vibratable in a trans-verse direction of the piezoelectric element as the piezoelectric element expands and contracts. Each of the beam members comprises an extension extending outwardly from the outer circumferential portion of the base and a rising portion joined to and extending across one of the extensions.

In the piezoelectric actuator according to the present invention, the beams are not straight, but are bent. Since the stroke of the bent beams is long, the profile size of the actuator is not increased as the stroke of the beams is increased. Since the stroke of the bent beams is long, the piezoelectric actuator produces a sufficient vibration amplitude, contributing to an increase in sound pressure when the piezoelectric actuator is used in an acoustic component. The piezoelectric actuator according to the present invention has a vibratory assembly vibratable based on the flexural motion of the extensions and the pivoting motion of the rising portions. Therefore, the vibration mode of the piezoelectric actuator is closer to a piston-type mode (the vibration mode of an electromagnetic actuator) than the structure of the related art in which the beams are simply extended straight.

In the above invention, the base and the beam members may be constructed as an integral member. The piezoelectric element is of a circular shape or a square shape. Two of the piezoelectric elements may be disposed on respective both sides of the base, providing a bimorph piezoelectric element. The piezoelectric element may be of a laminated structure including piezoelectric material layers and electrode layers which are alternatively stacked together.

With the arrangement of the present invention, more specifically, the rising portion and the extension should preferably extend across each other at an angle ranging from 90° to 150°. The extension or the rising portion may include a curved portion, and the curved portion may be included in the rising portion and have an end aligned with an end of the extension. Each of the beams may be of a structure with two bends. In other words, the piezoelectric actuator may further include another extension joined to and extending across the rising portion, the other extension having an end connected to the support member.

An acoustic component according to the present invention comprises the above piezoelectric actuator, and a vibratory membrane joined to at least a portion of the piezoelectric element, the base, or the extension of the piezoelectric actuator, wherein the acoustic component produces sound when the vibratory membrane is actuated by the piezoelectric actuator which serves as a drive source. An electronic device according to the present invention incorporates such an acoustic component or the above piezoelectric actuator.

### ADVANTAGES OF THE INVENTION

With the piezoelectric actuator according to the present invention, since the stroke of the beams is sufficient, it is possible to produce a high sound pressure when the piezoelectric actuator is incorporated in an acoustic component. Since the beams are not straight, but are bent, the vibration mode is close to the piston-type mode. Therefore, the acoustic component has good frequency characteristics. The beams thus constructed are effective to increase the stroke without it being necessary for piezoelectric actuator to have an increase profile size.

### BRIEF DESCRIPTION OF THE DRAWINGS

FIG. 1 is a perspective view showing the structure of a piezoelectric actuator according to a first exemplary embodiment;

FIG. 2 is a diagram illustrative of the operation of the piezoelectric actuator shown in FIG. 1;

FIG. 3 is a cross-sectional view showing a piezoelectric actuator of the related art by way of example;

FIG. 4 is a cross-sectional view showing the structure of a piezoelectric actuator according to a second exemplary embodiment;

FIG. 5 is a perspective view showing the structure of a piezoelectric actuator according to a third exemplary embodiment;

FIG. 6 is a plan view showing the structure of a piezoelectric actuator according to a fourth exemplary embodiment;

FIG. 7 is a plan view showing the structure of a piezoelectric actuator according to a fifth exemplary embodiment;

FIG. 8 is a perspective view showing the structure of a piezoelectric actuator according to a sixth exemplary embodiment;

FIG. 9 is a cross-sectional view showing the structure of a piezoelectric actuator according to a seventh exemplary embodiment;

FIG. 10 is a cross-sectional view showing the structure of a piezoelectric actuator according to an eighth exemplary embodiment;

FIG. 11 is a perspective view showing another structural example of a piezoelectric element;

FIG. 12 is a cross-sectional view showing the structure of an acoustic component according to a ninth exemplary embodiment;

FIG. 13 is a diagram illustrative of a vibration mode and a vibration speed ratio;

FIG. 14 is a diagram illustrative of measuring points for measuring an average vibration speed amplitude;

FIG. 15A is a plan view showing the structure of a piezoelectric actuator according to Inventive Example 1;

FIG. 15B is a cross-sectional view showing the structure of the piezoelectric actuator according to Inventive Example 1;

FIG. 16A is a plan view showing the structure of a piezoelectric actuator according to Comparative Example 1;

FIG. 16B is a cross-sectional view showing the structure of the piezoelectric actuator according to Comparative Example 1;

FIG. 17A is a plan view showing the structure of a piezoelectric actuator according to Inventive Example 2;

FIG. 17B is a cross-sectional view showing the structure of the piezoelectric actuator according to Inventive Example 2;

FIG. 18 is a cross-sectional view showing the structure of a piezoelectric actuator according to Inventive Example 3;

FIG. 19 is a view showing the structure of a piezoelectric element used in Inventive Example 4;

FIG. 20A is a plan view showing the structure of a piezoelectric actuator according to Inventive Example 5;

FIG. 20B is a cross-sectional view showing the structure of the piezoelectric actuator according to Inventive Example 5;

FIG. 21 is a graph showing the results of Inventive Example 6A;

FIG. 22 is a cross-sectional view showing the structure of an acoustic component according to Inventive Example 7;

FIG. 23 is a cross-sectional view showing the structure of an acoustic component according to Inventive Example 8;

FIG. 24 is a front elevational view showing an example of a cellular phone incorporating a piezoelectric actuator according to the present invention;

FIG. 25 is a cross-sectional view showing the structure of an acoustic component of the related art prepared according to Comparative Example 4;

FIG. 26 is a graph showing the frequency characteristics of acoustic components according to Inventive Examples 9, 10 and Comparative Examples 3, 4;

FIG. 27 is a cross-sectional view showing the structure of a piezoelectric actuator according to Inventive Example 12, the view showing only an elastic body;

FIG. 28 is a graph showing the correlation between distance X, a resonant frequency, and a maximum vibration speed amplitude as verified results of Inventive Example 12;

FIG. 29 is a cross-sectional view showing the structure of a piezoelectric actuator according to Inventive Example 13, the view showing only an elastic body;

FIG. 30 is a cross-sectional view showing the structure of a piezoelectric actuator according to Inventive Example 14, the view showing only an elastic body;

FIG. 31 is a perspective view showing the structure of a piezoelectric actuator of the related art;

FIG. 32 is a cross-sectional view schematically showing the vibration mode of the piezoelectric actuator shown in FIG. 31;

FIG. 33 is a perspective view showing the structure of another piezoelectric actuator of the related art;

FIG. 34A is a diagram illustrative of the vibration mode of a piezoelectric actuator, showing the vibration mode of an electromagnetic actuator; and

FIG. 34B is a diagram illustrative of the vibration mode of a piezoelectric actuator, showing the vibration mode of a general piezoelectric actuator.

### DESCRIPTION OF REFERENCE CHARACTERS

10, 10A piezoelectric actuator
11, 11A, 11B, 11C upper electrode layer
12 piezoelectric plate
13 lower electrode layer
14 electrode layer
24, 24A base
27, 27A support member
27a outer circumferential wall
30, 30A beam
35, 35A extension
35b drawn portion
36 rising portion
36a fixed end
37 curved portion
38 extension
50-57 piezoelectric actuator
61 vibratory membrane
70 acoustic component

### BEST MODE FOR CARRYING OUT THE INVENTION

Exemplary embodiments of the present invention will be described below with reference to the drawings.

### 1st Exemplary Embodiment

FIG. 1 is a perspective view showing the structure of a piezoelectric actuator according to the present exemplary embodiment. As shown in FIG. 1, piezoelectric actuator 50 according to the present exemplary embodiment comprises piezoelectric element 10 having two opposite principal surfaces (upper and lower surfaces as shown), base 24 supporting piezoelectric element 10 thereon, four beams 30 mounted on outer circumferential portions of base 24, and support member 27 supporting base 24 and piezoelectric element 10 fixed thereto through beams 30. Though piezoelectric actuator 50 is not limited to any particular attitude in use, it will be described below with respect to the attitude shown in FIG. 1 for illustrative purposes. In FIG. 1, the lateral direction represents a horizontal direction and the vertical direction represents a height direction. Base 24 and extensions 35 to be described later provide a horizontal plane.

Piezoelectric element 10 has piezoelectric plate 12 made of piezoelectric ceramics, and upper electrode layer 11 and lower electrode layer 13 are disposed respectively on the opposite principal surfaces of piezoelectric plate 12. Piezoelectric plate 12 has a rectangular profile as viewed in plan, and is polarized along the thickness direction indicated by the blank arrow in FIG. 1. When an alternating current is applied between upper electrode layer 11 and lower electrode layer 13 to generate an alternating electric field, piezoelectric element 10 expands and contracts to have its principal surfaces enlarged or shrunk.

Base 24 is made of an elastic body (a stretchable material) and has a profile identical to the profile of piezoelectric plate 12. Base 24 may be made of any of a wide range of materials which are lower in rigidity than the ceramic material of the piezoelectric element, such as a metal material (e.g., aluminum alloy, phosphor bronze, titanium, or titanium alloy) or a resin material (e.g., epoxy, acryl, polyimide, or polycarbonate). Lower electrode layer 13 of piezoelectric element 10 is fixed to the upper surface of base 24, so that base 24 restrains piezoelectric element 10. Piezoelectric element 10 and base 24 may be bonded to each other by an epoxy adhesive.

Support member 27 comprises a centrally open frame-like member and has sides to which the respective ends of beams 30 are attached. Support member 27 may serve as a casing of the piezoelectric actuator, and may be made of a resin material or a metal material.

In FIG. 1, support member 27 is illustrated as comprising a sheet-like member. Actually, support member 27 has a certain thickness. If the thickness of support member 27 is too small, then the rigidity of support member 27 is reduced to make support member 27 easily deformable. Support member 27 supports piezoelectric element 10, etc. with the beams, as described above. Therefore, support member 27 needs to be made of a material which has a certain degree of rigidity and which is resistant to vibrations in order not to obstruct the vibrations of piezoelectric element 10, etc.

Beams 30 are disposed one on each of the respective sides of the outer circumferential portion of base 24. Each of beams 30 comprises extension 35 extending straight outwardly from base 24 in the same plane (horizontal plane) as the base, and rising portion 36 joined to and bent at a right angle from extension 35. Rising portion 36 has an end fixed to support member 27.

Base 24 and beams 30 may be constructed as different members. However, from the standpoint of the ease with which they can be fabricated, they may be constructed as an integral member by blanking one sheet-like member, for example, to a predetermined shape and bending the blank. To prevent base 24 and beams 30 from undulating, it is effective for base 24 to have a square shape and for beams 30 to be identical in shape to each other.

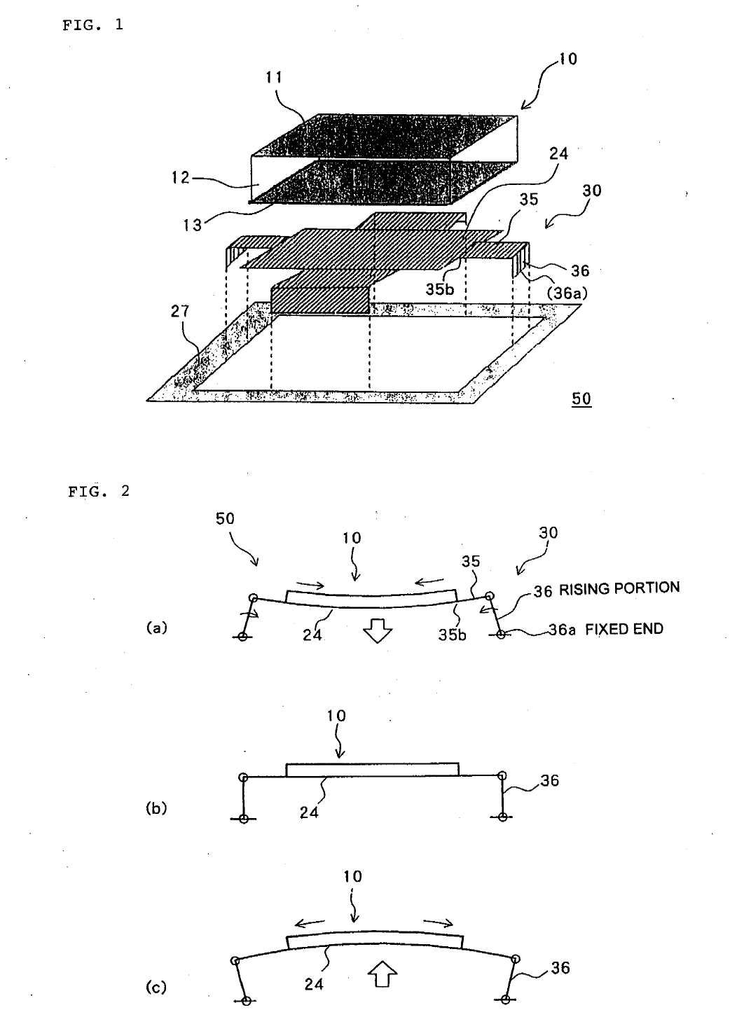

The mechanism for generating vibrations of the piezoelectric actuator, thus constructed, according to the present exemplary embodiment will be described below with reference to FIG. 2.

FIG. 2 shows at (b) a neutral state in which no voltage is applied to piezoelectric element 10. When a predetermined voltage is applied to the piezoelectric actuator, the area of piezoelectric element 10 is reduced as shown in FIG. 2 at (a). Since the lower surface of piezoelectric actuator 10 is restrained by base 24, the upper and lower surfaces of piezoelectric element 10 are deformed by different amounts, resulting in a concave deformation mode as shown. Base 24 itself also slightly contracts as piezoelectric element 10 contracts. Since base 24 contracts, the upper ends of rising portions 36 are pulled inwardly, so that rising portions 36 are pivoted about fixed ends 36a thereof.

When a voltage which is opposite to the above voltage is applied to piezoelectric element 10, the area of piezoelectric element 10 is enlarged as shown in FIG. 2 at (c). Due to the restraint effect of the base, the upper and lower surfaces of piezoelectric element 10 are deformed by different amounts, resulting in a convex deformation mode as shown. As base 24 expands, the upper ends of rising portions 36 are pushed outwardly, so that rising portions 36 are pivoted outwardly.

Piezoelectric actuator 50 according to the present exemplary embodiment alternately repeats the concave deformation mode and the convex deformation mode, causing base 24, extensions 35, and piezoelectric element 10 (hereinafter collectively referred to as “vibratory assembly”) to vibrate vertically.

According to the present exemplary embodiment, although the beams are not straight, but are bent, the beams as a whole have a sufficient stroke. Therefore, the piezoelectric actuator can produce a sufficient vibration amplitude without the need for an increase in its size. If the piezoelectric actuator which is capable of producing a large vibration amplitude is used as an acoustic component, then sound pressure can be increased.

The longer stroke of the beams means a reduction in the apparent rigidity of the beams. The reduction in the rigidity of the beams results in a reduction in the resonant frequency, which improves the frequency characteristics of the acoustic component for the following reasons:

Normally, it is comparatively difficult for an acoustic component to produce sounds at frequencies lower than resonant frequency f₀. Therefore, it is often customary to use sounds in a frequency range higher than resonant frequency f₀ as reproducible sounds. If resonant frequency f₀ that is determined by the structure of the piezoelectric actuator is in a high frequency band (e.g., 1500 Hz), then the acoustic component is capable of generating sounds in a band higher than 1500 Hz. It is important, therefore, to set resonant frequency f₀ as a lower frequency in order to reproduce music in a wider frequency band on cellular phones or the like.

A frequency band required to reproduce music on cellular phones or the like should preferably range from 1000 to 3000 Hz. Therefore, a piezoelectric actuator having resonant frequency f₀ of 1000 Hz or lower is suitable for use in cellular phones or the like. In particular, the actuator which can advantageously be reduced in size according to the present exemplary embodiment has a very high deal of potential.

As shown in FIG. 2, the vibratory assembly of the piezoelectric actuator according to the present exemplary embodiment vibrates based on the flexural motion of extensions 35 and base 24 and the pivoting motion of rising portions 36. Therefore, the vibration mode of the piezoelectric actuator is more like a pivot type than the structure of the related art in which the stroke of the beams is simply extended.

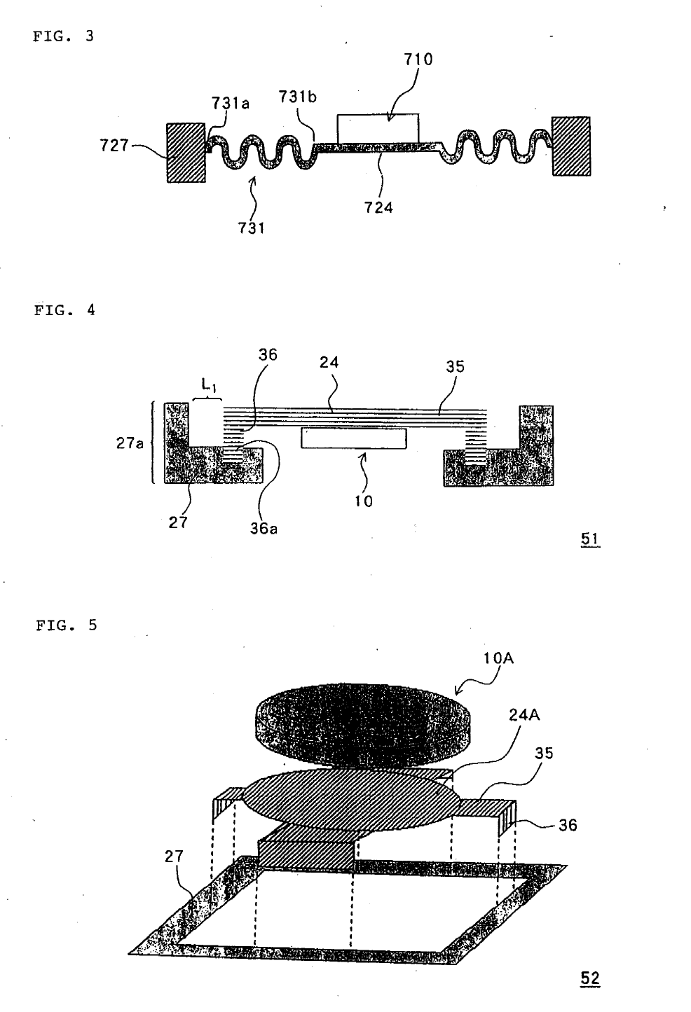

Piezoelectric actuator 50 according to the present exemplary embodiment is different from the bellows-like undulating structure of an elastic body according to the related art (JP-A No. 61-114216) with regard to the following aspects: A piezoelectric actuator is originally a mechanism connected to a load for transmitting power. Undulating structure 731 according to the related art as shown in FIG. 3 has reduced rigidity, cannot transmit forces generated by piezoelectric element 710 to support members 727, and the amount of vibration of the undulating structure 731 is greatly reduced because of the resistance of the air.

As can be seen from FIG. 2, one of the important aspects of the piezoelectric actuator according to the present invention is that drawn position 35b of extension 35 (which indicates the boundary between extension 35 and base 24) and fixed end 36a are not positioned in the same horizontal plane. Stated otherwise, it is important that drawn position 35b and fixed end 36a be disposed at different heights. With the structure shown in FIG. 3, however, drawn position 731b and fixed end 731a of undulating structure 731 are positioned in the same horizontal plane. According to this structure, forces generated as the piezoelectric element expands and contracts are absorbed by the undulating structure, and the piezoelectric actuator fails to produce a large vibration amplitude. According to the present invention, as described above, drawn position 35b and fixed end 36a are not positioned in the same horizontal plane for efficiently converting the forces generated by the piezoelectric element into vibrations. This feature also holds true for other exemplary embodiments to be described later. In each of second and ninth exemplary embodiments, the drawn position and the fixed end are not positioned in the same horizontal plane.

The piezoelectric actuator according to the present exemplary embodiment offers the following advantages in addition to the above:

The vibration characteristics of the piezoelectric actuator can easily be adjusted by changing the material properties, the number, and the shape (width and stroke) of the beams. In particular, since the stroke of the beams can be adjusted without changing the size of the casing (the size of the support member) of the piezoelectric actuator, the support member can be used as a common part and is effective to lower the manufacturing cost.

Heretofore, the resonant frequency of a piezoelectric actuator may be lowered by thinning the piezoelectric element. According to the present invention, the resonant frequency can be lowered by changing the stroke of the beams even if the piezoelectric element is relatively thick. Generally, a thin piezoelectric element has a high manufacturing cost because it tends to crack when the ceramics are baked and it tends to break when handled. According to the present invention, since there is no need to prepare such a thin piezoelectric element, the manufacturing cost can be reduced.

The piezoelectric actuator according to the present invention can be used as a vibration source or a sound source for small-sized game devices as well as cellular phones and notebook personal computers. Piezoelectric actuators using a piezoelectric element of ceramics have been disadvantageous in that the piezoelectric element is liable to break when it has dropped. When a portable electronic device as described above is in use, the user often lets it drop in error. Therefore, it has been considered that the piezoelectric actuator is not suitable for use in portable devices. In the piezoelectric actuator according to the present invention, however, since the piezoelectric element is fixed to the base supported by the beams, even when the piezoelectric actuator has dropped, the shock is absorbed by the beams as they are deformed, and the piezoelectric element is less liable to break. Therefore, the piezoelectric actuator according to the present invention can be appropriately used in portable devices.

### 2nd Exemplary Embodiment

The piezoelectric actuator according to the present invention is not limited to the above exemplary embodiment, but may be constructed as shown in FIG. 4.

Piezoelectric actuator 51 shown in FIG. 4 differs from the structure according to the first exemplary embodiment in that the position of piezoelectric element 10 is changed, i.e., piezoelectric element 10 is mounted on the lower surface of base 24. With this structure, when piezoelectric element 10 expands or contracts, the area of base 24 is increased or reduced, causing the vibratory assembly to vibrate vertically in the same manner as with the above exemplary embodiment.

Support member 27 according to the present exemplary embodiment has outer circumferential wall 27a on its side edge, though this is not an essential difference from the above exemplary embodiment. It is preferable to provide clearance L₁ between rising portions 36 and the inner surface of outer circumferential wall 27a. Since rising portions 36 make a pivot motion about fixed ends 36a as described above with reference to FIG. 2, if clearance L₁ is not provided, then rising portions 36 will tend to interfere with outer circumferential wall 27a, obstructing the vibrating motion.

### 3rd Exemplary Embodiment

The piezoelectric actuator according to the present invention is not limited to the above exemplary embodiments, but may be constructed as shown in FIG. 5.

Piezoelectric actuator 52 shown in FIG. 5 employs circular piezoelectric element 10A and hence circular base 24A. Other structural details are identical to those of the first exemplary embodiment. The structure of piezoelectric element 10A is not different from that of the first exemplary embodiment, and includes an upper electrode layer and a lower electrode layer respectively on the upper and lower surfaces of the piezoelectric plate.

Since piezoelectric element 10a is of a circular shape, the structure according to the present exemplary embodiment offers the following advantages: Since energy efficiency at the time that a circular element expands and contracts (diameter increasing motion) is higher than with a rectangular element, the structure according to the present exemplary embodiment produces a greater drive force when the same voltage is applied. When the greater drive force is transmitted to the beams, the piezoelectric actuator vibrates by an increased amount. Since the distance from the center to the peripheral edge of the circular element is constant, stresses produced when the vibration is propagated to the beams are dispersed uniformly, so that energy efficiency is increased and the amplitude is increased.

If the operation and advantages resulting from the device shape are taken into account, then the piezoelectric element and the surrounding structure should preferably be highly symmetrical. Specifically, the piezoelectric actuator should preferably have a highly symmetrical circular shape. Even if the piezoelectric actuator has a rectangular shape, provided that is close to a square shape, it is relatively highly symmetrical and can generate vibrations with good energy efficiency.

### 4th Exemplary Embodiment

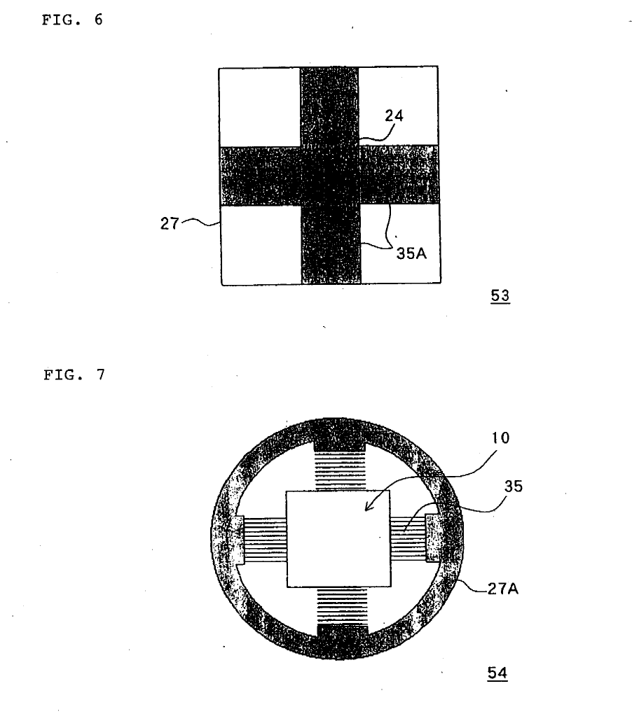

The piezoelectric actuator according to the present invention is not limited to the above exemplary embodiments, but may be constructed as shown in FIG. 6.

Piezoelectric actuator 53 shown in FIG. 6 employs a rectangular piezoelectric element as with the first exemplary embodiment, but has extensions 35A that have a different shape from base 24. Specifically, extensions 35A have the same width as the sizes of base 24. It is possible to manufacture an elastic body comprising an integral assembly of base 24 and four beams by cutting off the corners of a single sheet-like member and bending the distal ends of extensions 35A. However, the present exemplary embodiment is not limited to such an elastic body.

With piezoelectric actuator 53, thus constructed, according to the present invention, as the piezoelectric element expands and contracts, the area of base 24 increases and decreases, causing the vibratory assembly to vibration vertically as with the first exemplary embodiment.

### 5th Exemplary Embodiment

The piezoelectric actuator according to the present invention is not limited to the above exemplary embodiments, but may be constructed as shown in FIG. 7.

Piezoelectric actuator 54 shown in FIG. 7 differs from the structure according to the first exemplary embodiment in that the shape of support member 27 is changed, i.e., support member 27 has a circular profile. Other structural details are identical to those of the first exemplary embodiment. In FIG. 7, the portions of support member 27A to which the beams are connected project inwardly from portions (four portions) of the inner circumferential wall of a hollow cylindrical member. However, the present invention is not limited to such a structure. The beams may be directly connected to the support member that is provided as the hollow cylindrical member.

### 6th Exemplary Embodiment

According to the present invention, the structure of the beams is important for increasing the amplitude of the vibratory assembly and controlling the vibration mode. The beams are not limited to the above exemplary embodiments, but may be constructed as shown in FIG. 8.

Piezoelectric actuator 55 shown in FIG. 8 has curved portions 37 disposed between rising portions 36 and extensions 35. Curved portions 37 comprise upper portions of rising portions 36 that are curved semicircularly outwardly, and have ends aligned with the ends of extensions 35.

Curved portions 37 are not limited to any positions insofar as they are part of the beams, but may be disposed on extensions 35.

### 7 th Exemplary Embodiment

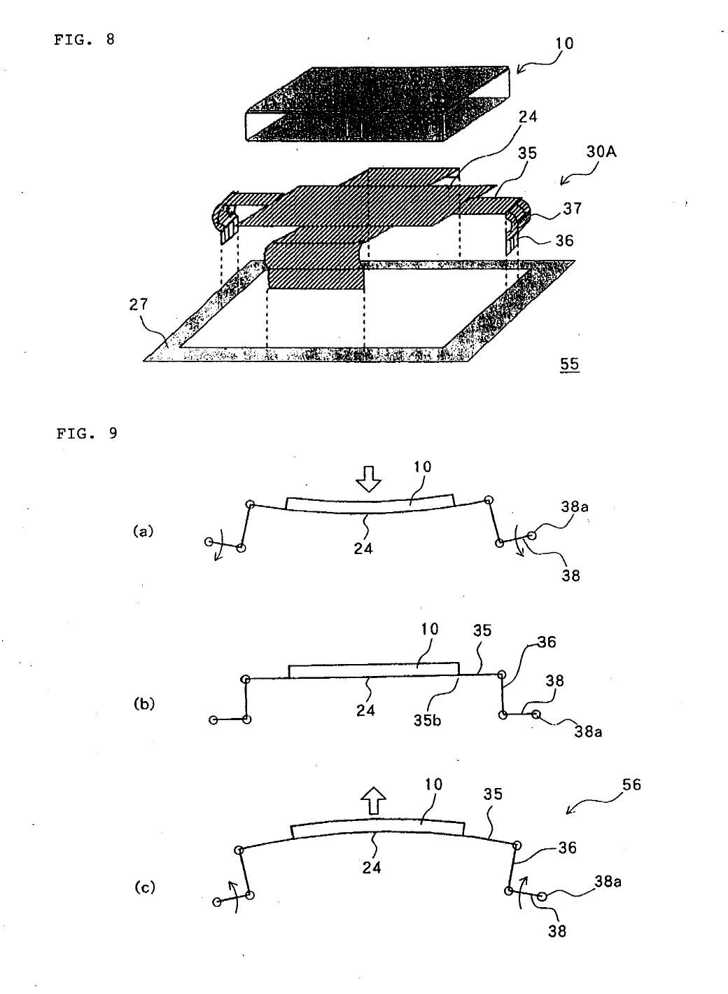

The piezoelectric actuator according to the present invention may have a structure shown in FIG. 9. Piezoelectric actuator 56 shown in FIG. 9 includes extensions 38 joined to the lower ends of rising portions 36 and extending perpendicularly to rising portions 36. Extensions 38 may be formed by bending outwardly the lower portions of rising portions 36. Extensions 38 have ends serving as fixed ends 38a fixed to the support member.

Piezoelectric actuator 56 thus constructed vibrates basically in the same manner as with the actuator according to the first exemplary embodiment shown in FIG. 2. Specifically, when a predetermined voltage is applied to piezoelectric element 10 in the neutral state shown in FIG. 9 at (b), the piezoelectric actuator is brought into a concave deformation mode while extensions 38 are making a pivoting motion as shown in FIG. 9 at (a). When an opposite voltage is applied, the piezoelectric actuator is brought into a convex deformation mode as shown in FIG. 9 at (c). The piezoelectric actuator repeats the two modes to cause the vibratory assembly to vibrate vertically.

For constructing the piezoelectric actuator according to the present exemplary embodiment, the beams may have a plurality of bent portions. It is important that drawn portion 35b and fixed end 38a not be positioned in the same horizontal plane.

### 8th Exemplary Embodiment

The embodiments in which the piezoelectric element is fixed to one surface of the base have been described above. The piezoelectric actuator according to the present invention may employ a bimorph piezoelectric element as shown in FIG. 10.

Piezoelectric actuator 57 shown in FIG. 10 has a laminated structure with piezoelectric elements 11A, 11B disposed respectively on the upper and lower surfaces of base 24. As indicated by the arrows in FIG. 10, piezoelectric elements 11A, 11B are polarized in opposite directions. When an alternating voltage is applied to each of the piezoelectric elements, one of them expands and the other contracts, causing vertical flexural vibrations due to the restraint effect between each piezoelectric element and base 24. Stated otherwise, according to the present exemplary embodiment, the bimorph piezoelectric elements produce a flexural motion by themselves. This structure is capable of producing greater drive forces than the above structures employing the single piezoelectric element.

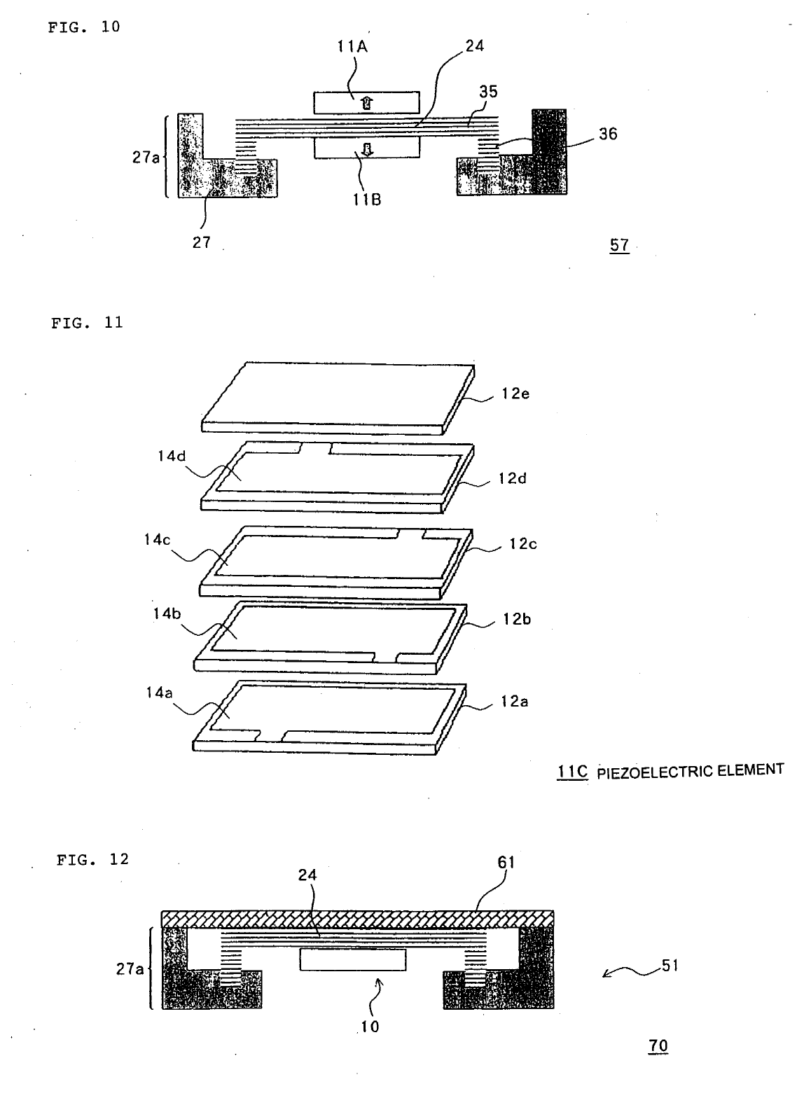

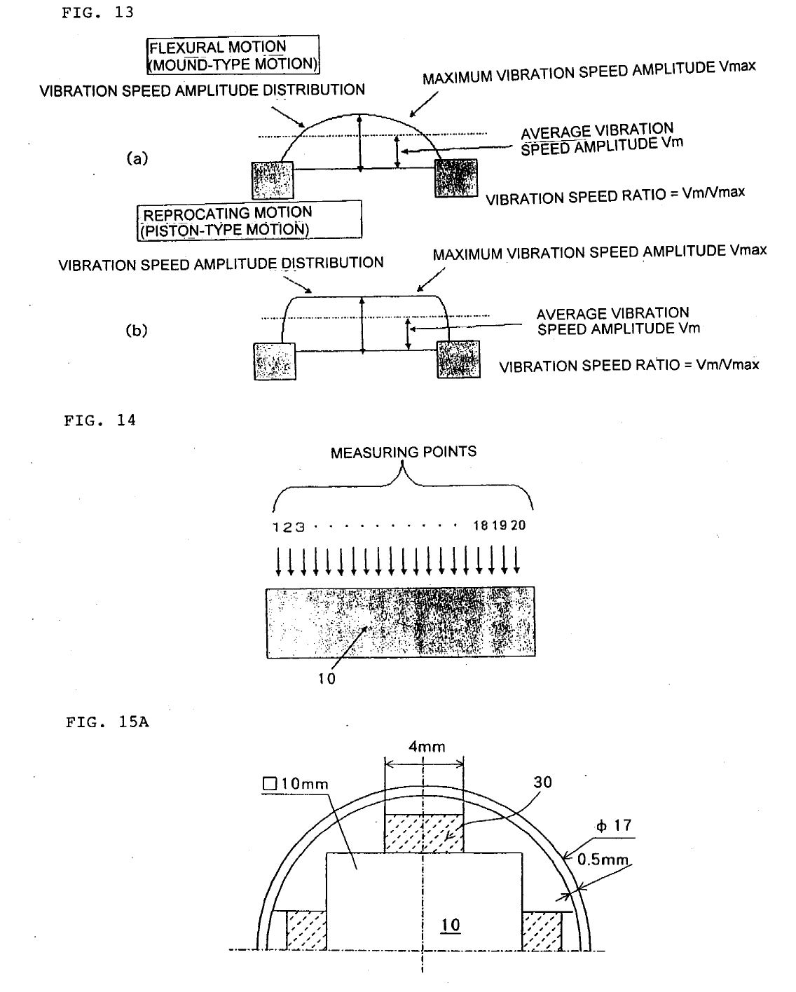

The piezoelectric element may have a laminated structure itself. The piezoelectric element having a laminated structure will be described below with reference to FIG. 11. As shown in FIG. 11, piezoelectric element 11C has a multilayer structure comprising five stacked layers of piezoelectric plates 12a through 12e made of a piezoelectric material, with electrode layers 14a through 14d each interposed between adjacent ones of the piezoelectric plates. The adjacent ones of the piezoelectric plates are polarized in opposite directions, and they are arranged such that the electric fields are oriented alternately in opposite directions. Since this structure increases the field intensity between the electrode layers, the drive forces produced by the piezoelectric elements as a whole are increased depending on the number of stacked piezoelectric plates.

### 9th Exemplary Embodiment

An example of an acoustic component according to the present invention will be described below with reference to FIG. 12. Acoustic component 70 shown in FIG. 12 comprises piezoelectric actuator 51 shown in FIG. 4 and vibratory membrane 61 applied to the upper surface of piezoelectric actuator 51. Specifically, vibratory membrane 61 has a central portion supported on the upper surface of base 24 and a peripheral portion fixed to the upper end of outer circumferential wall 27a of the support member. Vibratory membrane 61 is effective to suppress changes in sharp vibrations in the vicinity of the resonant frequency, and creates an acoustic component such as a speaker, a receiver, or the like which have smooth sound pressure/frequency characteristics.

Vibratory membrane 61 may be made of paper or organic film such as of polyethylene terephthalate. If vibratory membrane 61 is made of an insulating base material such as organic film, then metal interconnections for connection to piezoelectric element 10 may be formed on the base material by plating or the like, and may be used as electric terminal leads. Since the electrode material is prevented from being rendered conductive, the reliability is increased. If a vibratory membrane is applied to a plurality of piezoelectric actuators having different resonant frequencies, and the assembly is incorporated in an electronic device, then it is possible for bands of low sound pressures to make up for each other, and the electronic device is capable of producing high sound pressures over a wide range of frequencies.

If the piezoelectric element is disposed on the upper surface of base 24, then the vibratory membrane may be applied to a portion of the piezoelectric element. Alternatively, a portion of the vibratory membrane and a portion of the base or the extensions may be joined to each other to cause the vibratory membrane to vibrate.

### EXAMPLES

The characteristics of the piezoelectric actuator according to the present invention were evaluated based on Inventive Examples 1 through 12 and Comparative Examples 1 through 4 to confirm the advantages of the present invention. Evaluated items are shown below.

(Evaluation 1) The measurement of resonant frequencies: Resonant frequencies were measured when alternating voltage of 1 V was input.
(Evaluation 2) Maximum vibration speed amplitude: Maximum vibration speed amplitude Vmax (see FIG. 13) was measured when alternating voltage of 1 V was input.
(Evaluation 3) Average vibration speed amplitude: Vibration speed amplitudes were measured at 20 measuring points that are uniformly spaced laterally on the upper surface of piezoelectric element 10, and an average value thereof was calculated.
(Evaluation 4) Vibration mode: As shown in FIG. 13, “vibration speed ratio” is defined as an average vibration speed amplitude/a maximum speed amplitude, and a vibration mode is determined based on the value of the vibration speed ratio. Specifically, since the piezoelectric element makes a flexural motion (mound-type motion) as shown in FIG. 13(a) when the vibration speed ratio is small and the piezoelectric element makes a reciprocating motion (piston-type motion) as shown in FIG. 13(b) when the vibration speed ratio is large, the vibration speed ratio=0.8 is used as a threshold value in the Inventive Examples, and the piezoelectric element was judged as making a flexural motion when the vibration speed ratio is smaller than 0.8 and as making a piston-type motion the vibration speed ratio is equal to or greater than 0.8.
(Evaluation 5) The measurement of sound pressures: When an alternating voltage of 1 Vrms was input, the sound pressure at 1 kHz was measured by a microphone placed at a position that was 10 cm spaced from the device.
(Evaluation 6) Drop impact test: A drop impact stability test was conducted in which cellular phones incorporating piezoelectric actuators were caused to drop by gravity five times from a height of 50 cm. After the test, damage (cracks, etc) was visually confirmed, and sound pressure levels were measured.

### Inventive Example 1

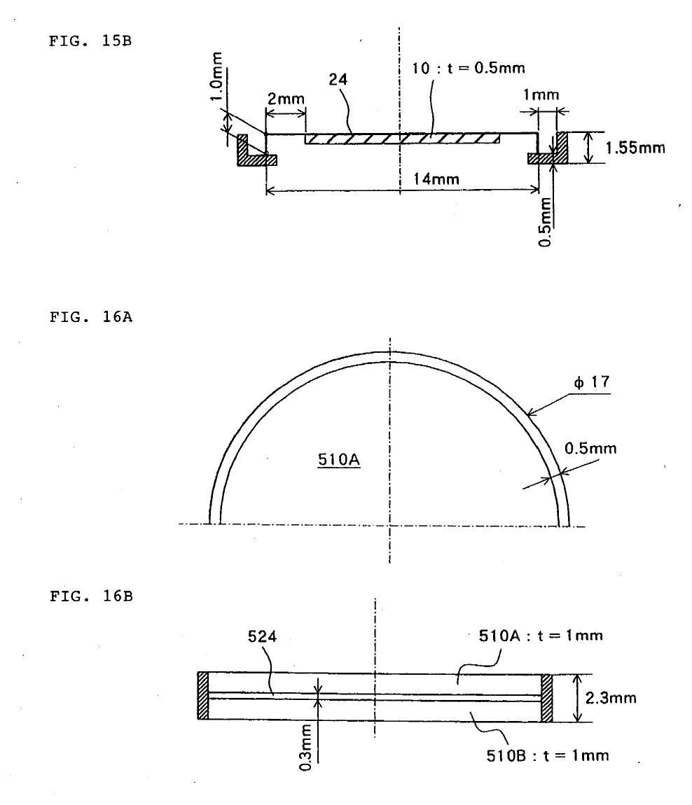

A piezoelectric actuator having piezoelectric element 10 applied to the lower surface of base 24 as shown in FIGS. 15A and 15B was fabricated according to Inventive Example 1.

Specific structural details are as follows:

Piezoelectric element: Upper and lower electrode layers, each having a thickness of 8 μm, were formed on the respective surfaces of a piezoelectric plate (piezoelectric material layer, see FIG. 1) having an outer shape=square with each side 10 mm long, thickness=0.5 mm.

Elastic body: An elastic body having a thickness of 0.05 mm was made of phosphor bronze. The “elastic body” refers to an integral structural body including a base, extensions, and rising portions.

Beams: Rising portion height 1.0 mm, extension length=2.0 mm, beam width: 4.0 mm, and beam bend angle=90°.

Support member: outer shape=circular with a diameter of 17 mm, thickness=1.55 mm, clearance L₁=1.0 m, and material=SUS304.

The piezoelectric plate was made of zirconate lead titanate ceramics, and the electrode layers were made of silver/palladium alloy (weight ratio 70%:30%). The piezoelectric element was manufactured by baking a green sheet at 1100° C. for 2 hours in the atmosphere and then polarizing the piezoelectric material layer. The piezoelectric element was bonded to the base of the elastic body by an epoxy adhesive.

### [Results]

Resonant frequency=635 Hz

Maximum vibration speed amplitude=260 mm/s

Vibration speed ratio=0.84

Vibration mode=piston-type motion

As can be seen from the above description, it was verified that the piezoelectric actuator according to the present Inventive Example had a low resonant frequency and a large vibration amplitude. The vibration speed ratio was 0.84 and the vibration mode was a piston-type mode.

### Comparative Example 1

A piezoelectric actuator of the related art which was free of beams as shown in FIGS. 16A and 16B was fabricated according to Comparative Example 1. According to Comparative Example 1, piezoelectric elements 510A, 510B were applied to the respective surfaces of base 524, providing a bimorph structure. Though the piezoelectric elements had the same outer shape, they were polarized in opposite directions.

Specific structural details are follows:

Piezoelectric element: Outer shape=circular with a diameter of 16 mm, thickness=0.5 mm. The piezoelectric elements had their outer circumferential portions joined to the support member.

Base: Had a thickness of 0.3 mm and was made of phosphor bronze (metal plate).

Beams: None.

Support member: outer shape=circular with a diameter of 17 mm,

thickness=2.3 mm.

### [Results]

Resonant frequency=1498 Hz

Maximum vibration speed amplitude=42 mm/s

Vibration speed ratio=0.37

Vibration mode=flexural motion

### Inventive Example 2

A piezoelectric actuator as shown in FIGS. 17A and 17B was fabricated according to Inventive Example 2. The piezoelectric actuator differs from the piezoelectric actuator according to Inventive Example 1 in that the beams 30 had a different structure. The beams had curved portions 37 as shown in FIG. 8. Other structural details are the same as those of the piezoelectric actuator according to Inventive Example 1.

Specific structural details are as follows:

Piezoelectric element: The same as with Inventive Example 1.

Elastic body: The same as with Inventive Example 1.

Beams: Rising portion height=1.0 mm, extension length (including curved portions)=2.0 mm, beam width: 4.0 mm, and radius of curvature of the curved portions=R2.0.

Support member: The same as with Inventive Example 1.

### [Results]

Resonant frequency=472 Hz

Maximum vibration speed amplitude=345 mm/s

Vibration speed ratio=0.91

Vibration mode=piston-type motion

As can be seen from the above description, it was verified that the piezoelectric actuator according to the present Inventive Example had a lower resonant frequency than with Inventive Example 1 and a large vibration amplitude. The vibration speed ratio was 0.91 and the vibration mode was a piston-type mode.

### Inventive Example 3

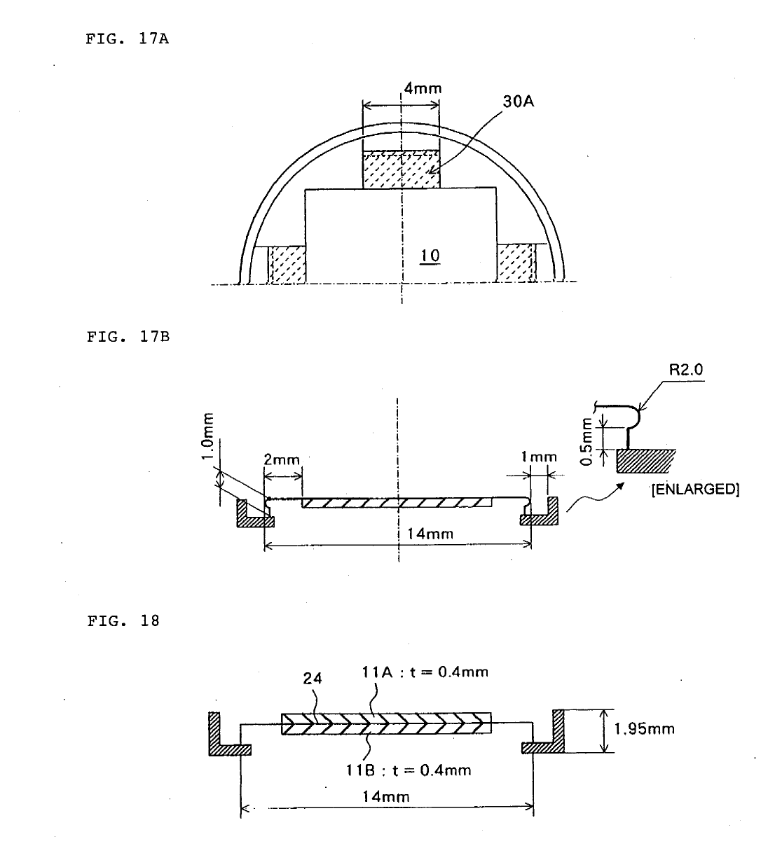

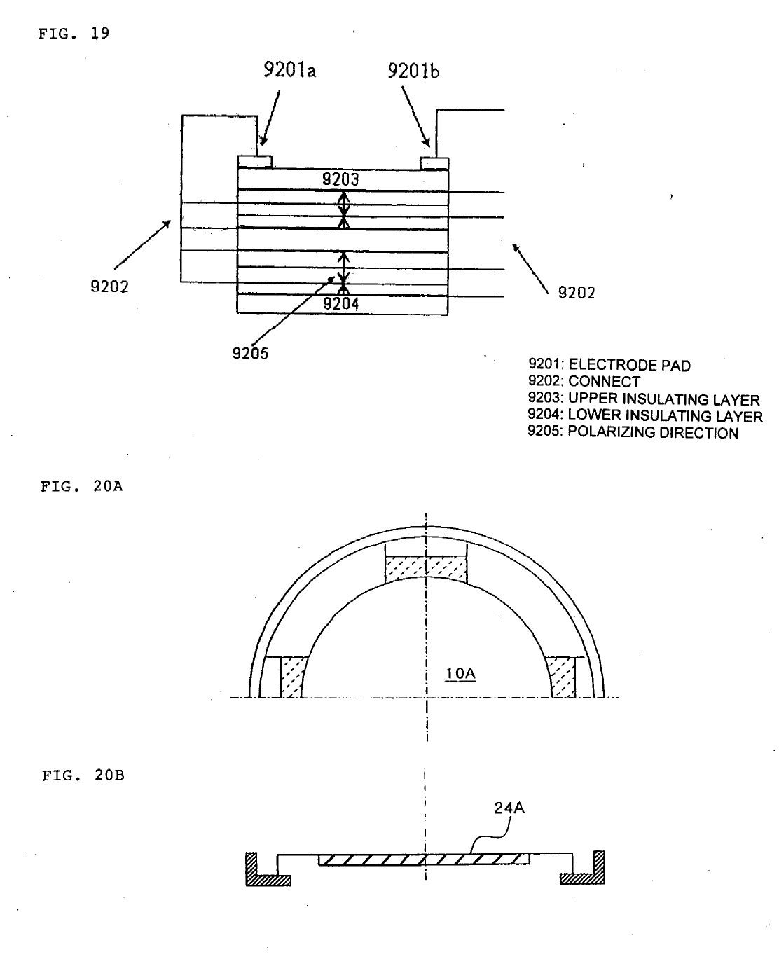

A piezoelectric actuator as shown in FIG. 18 was fabricated according to Inventive Example 3. The piezoelectric actuator differs from the piezoelectric actuator according to Inventive Example 1 in that piezoelectric elements are disposed on both surfaces of the base, providing a bimorph type. Other structural details are the same as those of the piezoelectric actuator according to Inventive Example 1.

Specific structural details are as follows:

Piezoelectric element: Outer shape=square with each side 10 mm long, thickness=0.4 mm. The upper and lower electrode layers of each piezoelectric element are the same as those of Inventive Example 1 and had a thickness of 8 μm.

Elastic body: The same as with Inventive Example 1.

Beams: The same as with Inventive Example 1.

Support member: Outer shape=circular with a diameter of 17 mm, a thickness=1.95 mm, clearance L₁=1.0 m.

### [Results]

Resonant frequency=662 Hz

Maximum vibration speed amplitude=298 mm/s

Vibration speed ratio=0.87

Vibration mode=piston-type motion

As can be seen from the above description, it was verified that the piezoelectric actuator according to the present Inventive Example had a low resonant frequency and a large vibration amplitude.

### Inventive Example 4

A piezoelectric actuator was fabricated according to Inventive Example 4 as follows: A piezoelectric actuator having a multilayer piezoelectric element was fabricated instead of the single-layer piezoelectric element of the piezoelectric actuator according to Inventive Example 1. Other structural details are the same as those of the piezoelectric actuator according to Inventive Example 1. Only the multilayer piezoelectric element is shown in FIG. 19. The piezoelectric element itself is basically of a structure which is the same as piezoelectric element 10C shown in FIG. 11. Specifically, electrode layers are disposed between the five piezoelectric material layers.

Specific structural details are follows:

Piezoelectric plate (piezoelectric material layer): Outer shape=square with each side 10 mm long, thickness=80 μm×5 layers.

Electrode layer: Thickness=3 μm×4 layers.

Final piezoelectric element: Outer shape=square with each side 10 mm long, thickness=about 0.5 mm.

Support member: Outer shape=circular with a diameter of 17 mm, thickness=1.55 mm, clearance L₁=1.0 m.

The piezoelectric element was manufactured by baking a green sheet at 1100° C. for 2 hours in the atmosphere. Thereafter, as shown in FIG. 19, silver electrodes, which wire (9202) the electrode layers, were formed, after which the piezoelectric material layers were polarized in polarizing directions indicated by arrows 9205. Insulating layers 9203, 9204 were formed respectively on the upper and lower surfaces. Electrode pads 9201a, b were provided on the surface of upper insulating layer 9203, joined by copper foil, and connected.

### [Results]

Resonant frequency=652 Hz

Maximum vibration speed amplitude=649 mm/s

Vibration speed ratio=0.91

Vibration mode=piston-type motion

As can be seen from the above description, it was verified that the piezoelectric actuator according to the present Inventive Example had a low resonant frequency and a large vibration amplitude. The vibration speed ratio was 0.91 and the vibration mode was a piston-type mode.

### Inventive Example 5

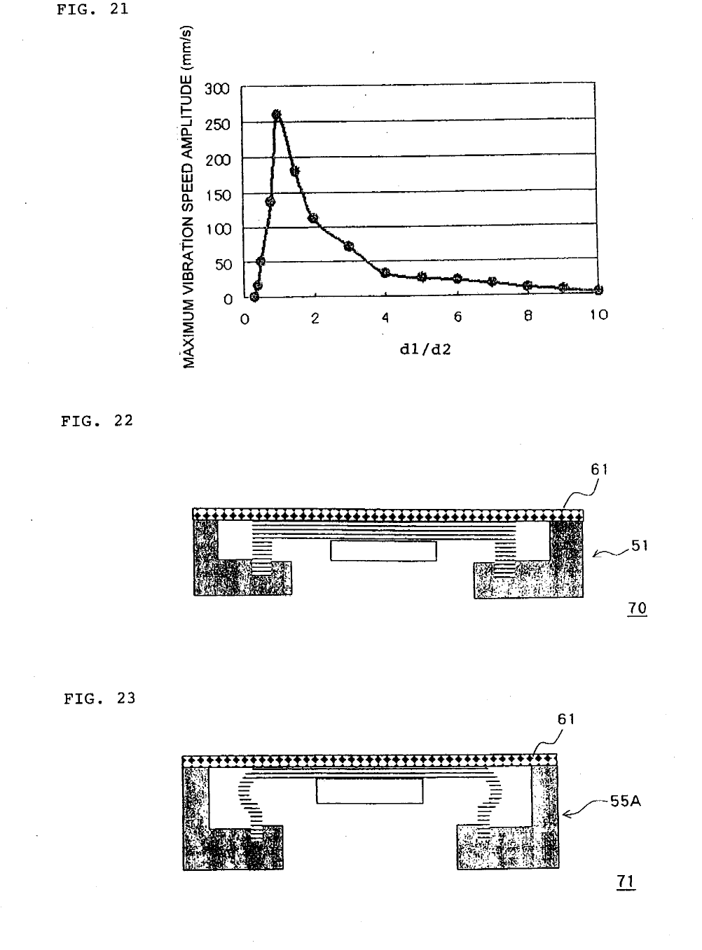

A piezoelectric actuator as shown in FIGS. 20A and 20B was fabricated according to Inventive Example 5. The piezoelectric actuator includes circular piezoelectric element 10A and correspondingly circular base 24A. Other structural details are the same as those of the piezoelectric actuator according to Inventive Example 1.

Piezoelectric element: Outer shape=circular with a diameter of 12 mm, thickness=0.5 mm.

Support member: Outer shape=circular with a diameter of 17 mm, thickness=1.55 mm.

### [Results]

Resonant frequency=532 Hz

Maximum vibration speed amplitude=296 mm/s

Vibration speed ratio=0.92

Vibration mode=piston-type motion

As can be seen from the above description, it was verified that the piezoelectric actuator according to the present Inventive Example had a low resonant frequency and a large vibration amplitude. The vibration speed ratio was 0.92 and the vibration mode was a piston-type mode.

### Inventive Example 6A

The results of a process for reviewing the effects that ratio d1/d2 of thickness d1 of a piezoelectric element and thickness d2 of an elastic body (base) has on the characteristics of a piezoelectric actuator will be described below as Inventive Example 6a. The piezoelectric actuator used in the present Inventive Example has a structure which is the same as with Inventive Example 1. Ratio d1/d2 was changed by only changing the thickness of the piezoelectric element. The results are shown in Table 1 and the graph of FIG. 21.

TABLE 1

| | d1/d2 | | Maximum |
|---|---|---|---|
| | piezoelectric | Resonant | vibration speed |
| | element thickness/ | frequency | amplitude |
| Inventive Example | base thickness | (Hz) | (mm/s) |
| Inventive Example 6a | 0.3 | 810 | 0.1 |
| Inventive Example 6b | 0.4 | 668 | 39 |
| Inventive Example 6c | 0.5 | 653 | 52 |
| Inventive Example 6d | 0.8 | 642 | 135 |
| Inventive Example 6e | 1.0 | 635 | 260 |
| Inventive Example 6f | 1.5 | 605 | 180 |
| Inventive Example 6g | 2.0 | 579 | 112 |
| Inventive Example 6i | 3.0 | 565 | 71.8 |
| Inventive Example 6j | 4.0 | 498 | 34.2 |
| Inventive Example 6k | 5.0 | 460 | 27.6 |
| Inventive Example 6l | 6.0 | 416 | 22.9 |
| Inventive Example 6m | 7.0 | 408 | 17.6 |
| Inventive Example 6n | 8.0 | 403 | 12.3 |
| Inventive Example 6o | 9.0 | 399 | 8 |
| Inventive Example 6p | 10.0 | 390 | 4 |

The acoustic component of a cellular phone should preferably have a sound pressure of about 80 dB, for example, so that the user can clearly hear ring tones even if the cellular phone is placed in a bag, a pocket, or the like. To achieve a sound pressure of about 80 dB, it is required that the maximum vibration speed amplitude of the piezoelectric actuator be at least 20 mm/s or higher.

Table 1 indicates that the maximum vibration speed amplitude is 20 mm/s or higher if ratio d1/d2 is in the range 0.4≦d1/d2≦6.0 (Inventive Examples 6b through 6l). If the value of d1/d2 is too small (i.e., if the thickness of the base is too large with respect to the thickness of the piezoelectric element), then since the rigidity of the base with respect to the piezoelectric element becomes high and the restraint effect of the base is increased, a sufficient amount of vibrations is not obtained. If the value of d1/d2, is too large (i.e., if the thickness of the base is too small with respect to the thickness of the piezoelectric element), then since the resistance of the base is low and forces generated by the piezoelectric element are not well transmitted to the base (and the beams connected thereto), a sufficient amount of vibrations is not obtained.

### Inventive Example 6B

Besides Inventive Example 6A, the results of an experiment in which the thickness of the piezoelectric element remained at 0.5 mm and only thickness d2 of the base was changed are shown in Table 2.

TABLE 2

| | d1/d2 | | Maximum |
|---|---|---|---|
| | piezoelectric | Resonant | vibration speed |
| | element thickness/ | frequency | amplitude |
| Inventive Example | base thickness | (Hz) | (mm/s) |
| Inventive Example 6q | 0.1 | 1350 | 0.005 |
| Inventive Example 6r | 0.5 | 1170 | 0.09 |
| Inventive Example 6s | 11.0 | 385 | 2.0 |
| Inventive Example 6t | 12.0 | 380 | 0.5 |
| Inventive Example 6u | 15.0 | 373 | 0.01 |

### Inventive Example 7

The results of a process for reviewing an acoustic component to which the present invention was applied will be shown.

An acoustic component as shown in FIG. 22 was fabricated according to Inventive Example 7. Acoustic component 70 comprised piezoelectric actuator 51 according to Inventive Example 1 and vibratory membrane 61 applied to piezoelectric actuator 51. Vibratory membrane 61 was made of polyethylene terephthalate (PET) film having a thickness=0.05 mm.

### [Results]

Resonant frequency=633 Hz

Sound pressure level=95 dB.

### Inventive Example 8

An acoustic component as shown in FIG. 23 was fabricated according to Inventive Example 8. Acoustic component 71 comprised piezoelectric actuator 55A according to Inventive Example 2 and vibratory membrane 61 that was applied to piezoelectric actuator 55A. Vibratory membrane 61 was the same as with Inventive Example 7.

### [Results]

Resonant frequency=503 Hz

Sound pressure level=99 dB.

### Comparative Example 2

To compare the advantages of the acoustic components according to Inventive Examples 7, 8, an acoustic component of the related art having a vibratory membrane applied to piezoelectric actuator according to Comparative Example 1 was fabricated.

### [Results]

Resonant frequency=1498 Hz

Sound pressure level=65 dB.

### Inventive Example 9

Cellular phones incorporating acoustic components will be described with respect to Inventive Examples 9 through 11 and Comparative Example 3.

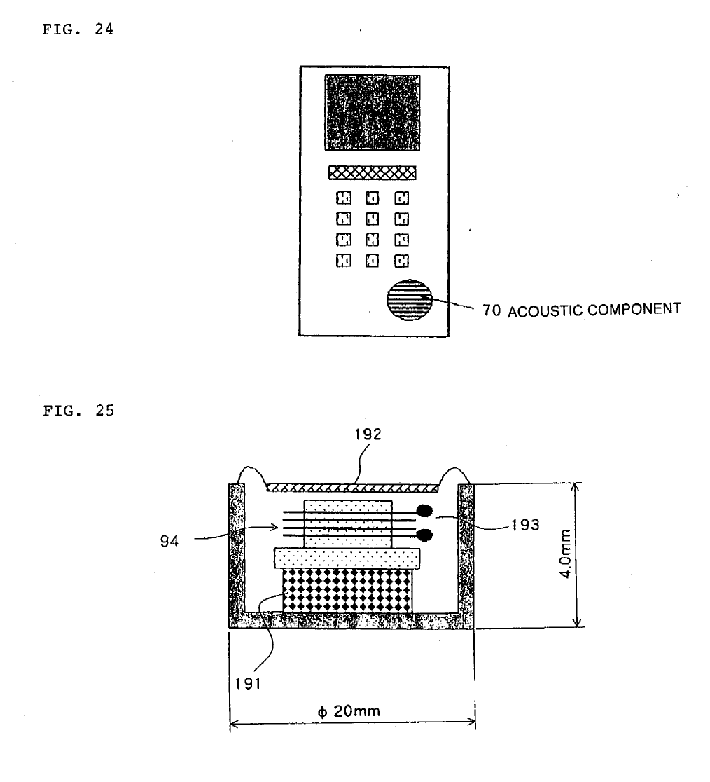

A cellular phone as shown in FIG. 24 was prepared according to Inventive Example 9, and acoustic component 70 according to Inventive Example 7 (see FIG. 22) was incorporated in the cellular phone. A sound pressure level and frequency characteristics were measured using a microphone placed at a position that was spaced 30 cm from the acoustic component. A drop shock test was also conducted.

### [Results]

Resonant frequency=643 Hz

Sound pressure level=93 dB

Frequency characteristics: Flat characteristics were exhibited (see FIG. 26).

Drop shock test: After the cellular phone was dropped five times, no crack was found in the piezoelectric element. After the test, the sound pressure level was measured as 92 dB.

### Inventive Example 10

A cellular phone as shown in FIG. 24 was prepared according to Inventive Example 10, and acoustic component 71 according to Inventive Example 8 (see FIG. 23) was incorporated in the cellular phone. The sound pressure level and frequency characteristics were measured using a microphone placed at a position that was spaced 30 cm from the acoustic component. A drop shock test was also conducted.

### [Results]

Resonant frequency=497 Hz

Sound pressure level=98 dB

Frequency characteristics: Flat characteristics were exhibited (see FIG. 26).

Drop shock test: After the cellular phone was dropped five times, no crack was found in the piezoelectric element. After the test, the sound pressure level was measured as 98 dB.

### Comparative Example 3

A cellular phone as shown in FIG. 24 was prepared according to Comparative Example 3, and the acoustic component according to Comparative Example 2 was incorporated in the cellular phone. The sound pressure level and frequency characteristics were measured using a microphone placed at a position that was spaced 30 cm from the acoustic component. A drop shock test was also conducted.

### [Results]

Resonant frequency=1520 Hz

Sound pressure level=66 dB

Frequency characteristics: Characteristics having a lot of peaks and dips were exhibited (see FIG. 26).

Drop shock test: After the cellular phone was dropped twice, a crack was found in the piezoelectric element. At the same time, the sound pressure level was measured as 50 dB or less.

### Comparative Example 4

An acoustic component of the related art as shown in FIG. 25 was pre-pared according to Comparative Example 4. The acoustic component shown in FIG. 25 includes permanent magnet 191, voice coil 193, and vibratory plate 192. When a current is passed through the voice coil via electric terminals 94, a magnetic force is generated to attract and repel vibratory plate 192 for generating sounds. The acoustic component has a circular outer shape having a diameter of 20 mm and a thickness of 4.0 mm.

The sound pressure level and frequency characteristics of the acoustic component thus constructed were measured using a microphone placed at a position that was spaced 30 cm from the acoustic component.

### [Results]

Resonant frequency=810 Hz

Sound pressure level=83 dB.

As can be seen from the graph shown in FIG. 26, the acoustic components employing the piezoelectric actuators according to Inventive Examples 9, exhibited frequency characteristics close to those of Comparative Example 4 (electromagnetic actuator). The piezoelectric actuators of the related art according to Comparative Example 3 exhibited frequency characteristics having a lot of peaks and dips. These facts verified that the acoustic components according to the present invention had improved frequency characteristics. In particular, in Inventive Examples 9, 10, resonant frequencies f₀ were lower than resonant frequency f₀ of Comparative Example 3, verifying that the acoustic components according to the present invention had an increased frequency band. According to Inventive Examples 9, 10, the sound pressure level was higher than with Comparative Example 3.

### Inventive Example 11

A notebook personal computer incorporating the acoustic component according to Inventive Example 7 was fabricated according to Inventive Example 11. The sound pressure level and frequency characteristics were measured using a microphone placed at a position that was spaced 30 cm from the acoustic component. A drop shock test was also conducted.

### [Results]

Resonant frequency=623 Hz

Sound pressure level=91 dB

Drop shock test: After the cellular phone was dropped five times, no crack was found in the piezoelectric element. After the test, the sound pressure level was measured as 89 dB.

### Experimental Example 12

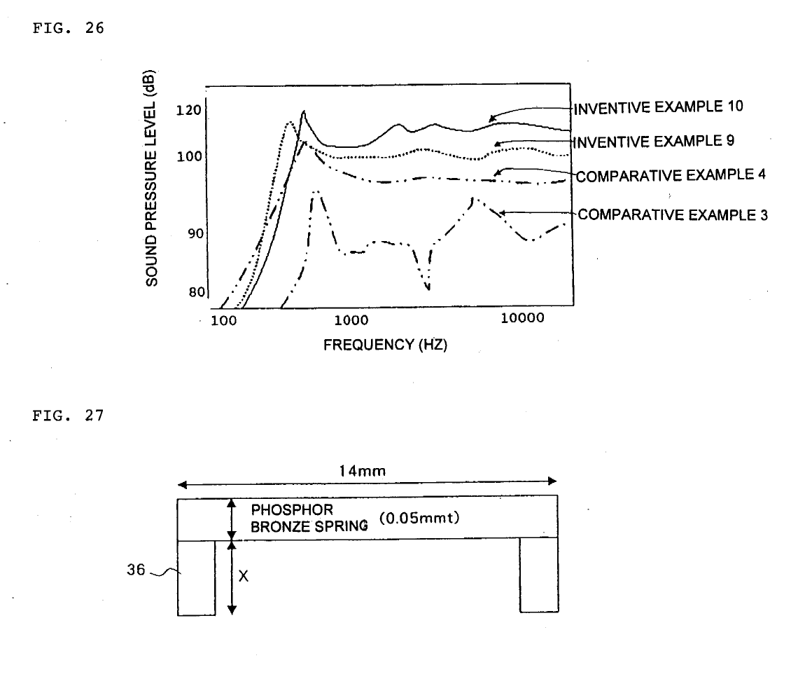

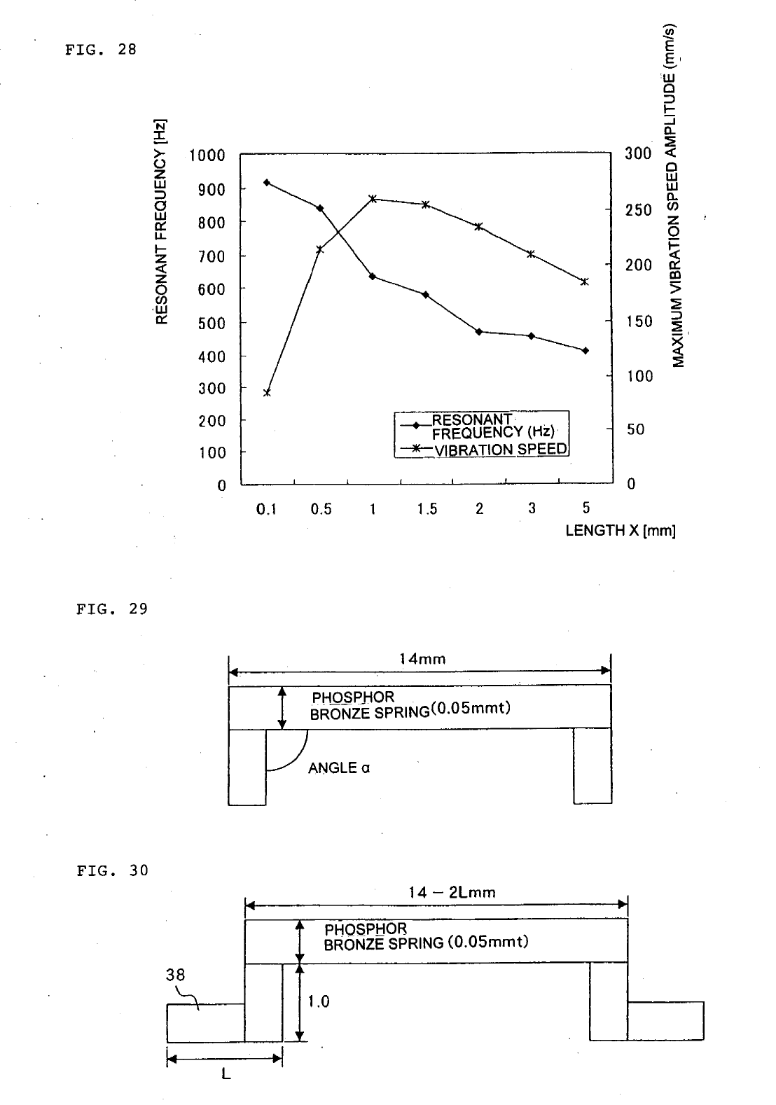

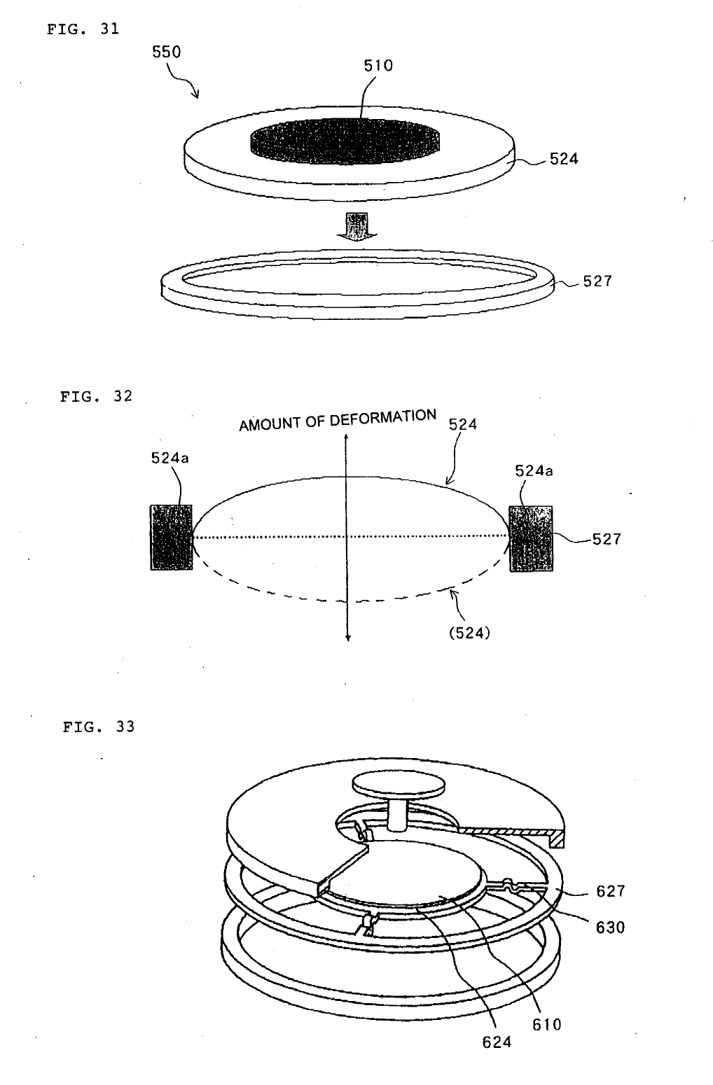

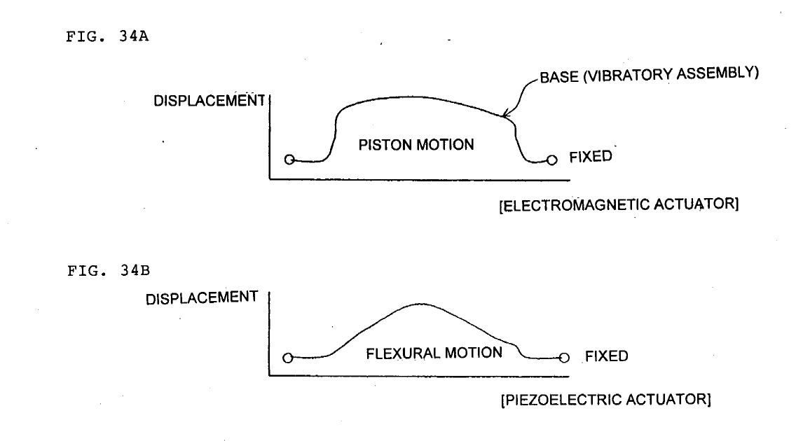

The results of a process for checking the correlation between the length of rising portions 36 (see FIG. 2) and the characteristics of the piezoelectric actuator will be described below. As shown in FIG. 27, using the actuator according to Inventive Example 1 as a base, an elastic body fabricated by bending a phosphor bronze spring having a thickness of 0.05 mm was used, and length X of rising portion 36 was changed from 0.1 mm to 5.0 mm, and resonant frequencies and maximum vibration speed amplitudes were measured. The length in the lateral direction of the upper surface of the elastic body (the length of the base and the two extensions) was 14 mm. The results are shown in Table 3 and the graph of FIG. 28. In FIG. 28, the horizontal axis represents length X, the left vertical axis the resonant frequency, and the right vertical axis the maximum vibration speed amplitude.

TABLE 3

| | Resonant frequency | Maximum vibration |
|---|---|---|
| X (mm) | (Hz) | speed amplitude (mm/s) |
| 0.1 | 915 | 85 |
| 0.5 | 840 | 215 |
| 1.0 | 635 | 260 |
| 1.5 | 580 | 255 |
| 2.0 | 470 | 235 |
| 3.0 | 455 | 210 |
| 5.0 | 410 | 185 |

### Inventive Example 13

The results of a process for checking the correlation between angle α (see FIG. 29) of rising portions 36 and the characteristics of the piezoelectric actuator will be described below. As shown in FIG. 29, using the actuator according to Inventive Example 1 as a base, an elastic body fabricated by bending a phosphor bronze spring having a thickness of 0.05 mm was used, and angle α of the rising portions with respect to the extensions was changed from 90° to 180°, and resonant frequencies and maximum vibration speed amplitudes were measured. The results are shown in Table 4. When angle α is 180°, the rising portions extend straight outwardly from the extensions, and hence are flat.

TABLE 4

| | Resonant frequency | Maximum vibration |
|---|---|---|
| α (degrees) | (Hz) | speed amplitude (mm/s) |
| 90 | 635 | 260 |
| 120 | 625 | 305 |
| 150 | 655 | 285 |
| 180 | 695 | 105 |
| (flat) | | |

### Inventive Example 14

The results of a process for checking the correlation between length L (see FIG. 30) of extensions 38 and the characteristics of the piezoelectric actuator will be described below. As shown in FIG. 30, in a piezoelectric actuator having the same structure as shown in FIG. 9, length L of extensions 38 was changed from 0 to 2.0 mm, and resonant frequencies and maximum vibration speed amplitudes were measured. The results are shown in Table 5. The elastic body was fabricated by bending a phosphor bronze spring having a thickness of 0.05 mm as with the above Inventive Examples. The dimensions of all the rising portions were 1.0 mm. Though not shown in detail in FIG. 30, the piezoelectric elements and the support members were identical to those according to Inventive Example 1.

TABLE 5

| | Resonant frequency | Maximum vibration |
|---|---|---|
| L (mm) | (Hz) | speed amplitude (mm/s) |
| 0 | 635 | 260 |
| 0.5 | 605 | 275 |
| 1.0 | 555 | 320 |
| 1.5 | 500 | 205 |
| 2.0 | 440 | 110 |

1. A piezoelectric actuator comprising:
a piezoelectric element having two opposite principal surfaces, for expanding and contracting to cause said principal surfaces to be enlarged or contracted depending on the state of an electric field;
a base made of a stretchable material, one of said principal surfaces being applied to said base; and
a plurality of beam members having ends connected to an outer circumferential portion of said base and other ends connected to a support member;
wherein said base is vibratable in a transverse direction of said piezoelectric element as said piezoelectric element expands and contracts;
each of said beam members comprising an extension extending outwardly from the outer circumferential portion of said base and a rising portion joined to and extending across one of said extensions.

2. The piezoelectric actuator according to claim 1, wherein said ends and said other ends of said beam members are not positioned in a plane parallel to a surface of said base.

3. The piezoelectric actuator according to claim 1, wherein said base and said beam members are constructed as an integral member.

4. The piezoelectric actuator according to claim 1, wherein said piezoelectric element has a circular shape.

5. The piezoelectric actuator according to claim 1, wherein said piezoelectric element has a square shape.

6. The piezoelectric actuator according to claim 1, wherein two of said piezoelectric elements are disposed on respective both sides of said base.

7. The piezoelectric actuator according to claim 1, wherein said piezoelectric element has a laminated structure including piezoelectric material layers and electrode layers which are alternatively stacked together.

8. The piezoelectric actuator according to claim 1, wherein said rising portion and said extension extend across each other at an angle ranging from 90° to 150°.

9. The piezoelectric actuator according to claim 1, wherein said extension or said rising portion includes a curved portion.

10. The piezoelectric actuator according to claim 9, wherein said curved portion is included in said rising portion and has an end aligned with an end of said extension.

11. The piezoelectric actuator according to claim 1, further including another extension joined to and extending across said rising portion, said other extension having an end connected to said support member.

12. An acoustic component comprising a piezoelectric actuator according to claim 1, and a vibratory membrane joined to at least a portion of said piezoelectric element, said base, or said extension of said piezoelectric actuator, wherein said acoustic component produces sound when said vibratory membrane is actuated by said piezoelectric actuator which serves as a drive source.

13. An electronic device incorporating an acoustic component according to claim 12.

14. An electronic device incorporating a piezoelectric actuator according to claim 1.
